(19) United States
(12) Patent Application Publication
(10) Pub. No.: US 2019/0361421 A1
(43) Pub. Date: Nov. 28, 2019

(54) SERVO CONTROL DEVICE

(71) Applicant: Mitsubishi Electric Corporation, Chiyoda-ku (JP)

(72) Inventors: Takeshi TSUDA, Tokyo (JP); Goh SATO, Tokyo (JP); Shinya NISHINO, Tokyo (JP)

(73) Assignee: Mitsubishi Electric Corporation, Chiyoda-ku (JP)

(21) Appl. No.: 16/080,929

(22) PCT Filed: Nov. 10, 2017
(86) PCT No.: PCT/JP2017/040610

§ 371 Date: Aug. 29, 2018

(51) Int. Cl. G05B 19/404; G05B 13/02; G06N 3/04

(52) U.S. Cl. CPC G05B 19/404; G05B 2219/32335; G06N 3/0454; G05B 13/027

(57) ABSTRACT

The present invention is a servo control device that controls a servomotor based on a command position. The servo control device includes a correction unit that corrects the command position using a first neural network that performs processing based on parameters representing a network structure, and a servo amplifier that controls the servomotor based on a corrected command position outputted from the correction unit. The correction unit corrects the command position based on the corrected command position and the actual position of the servomotor.

### FIELD

The present invention relates to a servo control device that drives and controls a motor that drives controlled object such as a machine tool.

### BACKGROUND

Generally, a servo control device that drives and controls a motor that drives a machine tool performs control for drive current to the motor so as to achieve a position and a speed specified by a command value generation device such as a Numerical Control (NC) device or a motion controller. In particular, when a working tool moves on a movement trajectory specified by a machining program, the drive control of the motor is performed while precisely managing the position. The drive control of the motor has a problem in that a trajectory error occurs due to the influence of friction disturbance when the rotational direction of the motor is reversed. This trajectory error is called quadrant protrusion or lost motion. So far, various methods for reducing trajectory errors have been proposed.

For example, in the invention disclosed in Patent Literature 1, for a controlled object that performs repetitive operation, the error amount of a trajectory error generated when the controlled object is operated in advance is stored, and is used as a correction amount when an identical program is executed thereafter to correct command values.

In the invention disclosed in Patent Literature 2, a neural network (NN) is disposed in a torque feedback loop, and the configuration of the NN is changed every moment to correct errors caused by backlash.

In the invention disclosed in Patent Literature 3, in order to suppress hand vibration of a robot, an NN is used to estimate the hand acceleration to correct torque commands.

### CITATION LIST

### Patent Literature

Patent Literature 1: Japanese Patent Application Laid-open No. 2004-234327

Patent Literature 2: U.S. Pat. No. 7,080,055

Patent Literature 3: Japanese Patent Application Laid-open No. H6-35525

### SUMMARY

### Technical Problem

In the invention described in Patent Literature 1, it is necessary to execute a machining program beforehand at least once in order to calculate an error correction amount. That is, when a new machining program is executed, there is a problem in that high precision control cannot be performed from an initial operation. In addition, there is a problem in that the machine is occupied by performing a preliminary operation, and the productivity is lowered. Furthermore, correction data corresponding to the length of a machining program is required, and it is thus necessary to accumulate enormous correction data for a program for long-time machining.

In the invention described in Patent Literature 2, update processing of the NN configuration is performed in addition to correction amount calculation. Thus, when it is necessary to complicate the configuration of the NN, such as when the behavior of an object to learn (backlash etc.) becomes more complicated, the processing load may become higher than or equal to processing load in the correction amount calculation. This also affects processing for controlling the motor other than the NN processing, resulting in a problem in that motor control in a predetermined cycle cannot be performed. In the invention described in Patent Literature 2, the NN is configured as a part of a control block, and thus there is a problem in that it is difficult to distribute processing.

In the invention described in Patent Literature 3, when torque correction using estimation results in the NN is executed, the characteristics of the controlled object (the robot hand) learned by the NN change, and the NN having parameters that have been determined based on past measured data and learning results can no longer be used continuously for correction processing, or even if the NN is continuously used for the correction processing, the correction accuracy is lowered. Also, while the torque correction using estimation results in the NN is executed, an acceleration sensor is removed, so that the learning cannot be continued. If it is attempted to continue the learning of the NN with the acceleration sensor attached, the behavior of the controlled object (the robot hand) varies depending on whether the torque correction using the NN is executed or not. That is, because the characteristics of the controlled object change depending on whether or not the torque correction using the NN is executed, it is impossible to utilize past measured data and learning results. Therefore, there is a problem in that correction by the NN and learning of the NN cannot be performed continuously at the same time.

The present invention has been made in view of the above. It is a first object of the present invention to provide a servo control device capable of continuing correction processing by an NN utilizing past measured data and learning results without lowering correction accuracy even when performing the correction processing using the NN. It is a second object of the present invention to provide a servo control device capable of updating parameters used in the correction processing without affecting processing for controlling a motor other than NN processing even when performing correction by the NN and learning of the NN continuously at the same time.

### Solution to Problem

In order to solve the above-described problems and achieve the objects, the present invention is a servo control device that controls a servomotor based on a command position. The servo control device includes a correction unit that corrects the command position using a first neural network that performs processing based on parameters representing a network structure, and a servo amplifier that controls the servomotor based on a corrected command position outputted from the correction unit. The correction unit corrects the command position based on the corrected command position and an actual position of the servomotor.

### Advantageous Effects of Invention

The servo control device according to the present invention achieves an effect of being capable of continuing the correction processing by the NN utilizing past measured data and learning results even when performing the correction processing using the NN.

### BRIEF DESCRIPTION OF DRAWINGS

FIG. 1 is a diagram illustrating a configuration example of a servo control device according to a first embodiment.

FIG. 2 is a diagram illustrating another configuration example of the servo control device according to the first embodiment.

FIG. 3 is a diagram illustrating a configuration example of a servo control device according to a second embodiment.

FIG. 4 is a diagram illustrating another configuration example of the servo control device according to the second embodiment.

FIG. 5 is a diagram illustrating a configuration example of a correction unit according to a third embodiment.

FIG. 6 is a diagram illustrating a configuration example of a correction unit in a case where no communication delay occurs. FIG. 7 is a flowchart illustrating an example of an operation procedure of the correction unit according to the third embodiment.

FIG. 8 is a diagram illustrating a processing circuit for realizing the servo control device according to the first to third embodiments.

### DESCRIPTION OF EMBODIMENTS

Hereinafter, a servo control device according to embodiments of the present invention will be described in detail with reference to the drawings. Note that the invention is not limited to the embodiments.

### First Embodiment

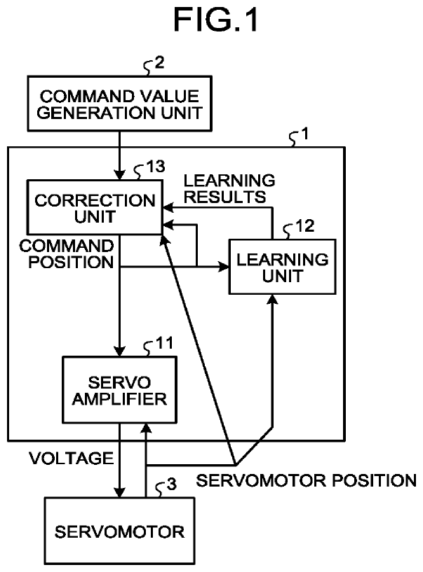

FIG. 1 is a diagram illustrating a configuration example of a servo control device according to a first embodiment of the present invention. A servo control device 1 according to the first embodiment generates a voltage for driving a servomotor 3 based on a command position generated by a command value generation unit 2, and applies the voltage to the servomotor 3. The command position is a command value for specifying the position of the servomotor 3. The servo control device 1 includes a servo amplifier 11, a learning unit 12, and a correction unit 13.

The command value generation unit 2 is formed by a device that outputs a command position to the servomotor 3 at command value generation control cycle intervals that are predetermined time intervals. The command value generation unit 2 is realized by, for example, a numerically controlled device, and generates position commands using a known technique.

The servo amplifier 11 of the servo control device 1 is a device that controls he position, speed, and acceleration of the servomotor 3 at servo control cycle intervals that are predetermined time intervals, and performs control so that the actual position of the servomotor 3 coincides with a command position generated the command value generation unit 2. In actuality, the servo amplifier 11 performs control so that the actual position of the servomotor 3 coincides with a command position that has been corrected by the correction unit 13 described later. The command value generation control cycle in which the command value generation unit 2 generates a command position, and the servo control cycle in which the servo amplifier 11 controls the servomotor 3 may be the same cycle or different cycles. When these are different cycles, a means for compensating for the cycle difference may be provided in the servo amplifier 11. For example, the servo amplifier 11 includes a means for holding the latest command position inputted from the correction unit 13, and performs control so that the actual position of the servomotor 3 coincides with a held command position, that is, the latest command position. Hereinafter, the “actual position of the servomotor 3” may be simply referred to as the “position of the servomotor 3” in order to prevent complication of the explanation.

The servomotor 3 is a drive unit for performing drive control of a machine tool via a power transmission mechanism such as a ball screw not illustrated, and rotates under the application of voltage from the servo amplifier 11. A position detector such as an encoder is attached to the servomotor 3. The position detector detects the position of the servomotor 3. The position detector outputs a detected position to the servo control device 1. A position detected by the position detector is inputted to the servo amplifier 11, the learning unit 12, and the correction unit 13 in the servo control device 1.

In addition to the position of the servomotor 3 detected by the position detector attached to the servomotor 3, a command position that has been corrected by the correction unit 13 is inputted to the learning unit 12 of the servo control device 1. As illustrated in FIG. 1, a command position that has been corrected by the correction unit 13 is a command position inputted to the servo amplifier 11. The learning unit 12 includes a neural network (hereinafter referred to as NN), and performs learning for predicting the position of the servomotor 3 at a predetermined fixed time ahead, using the position of the servomotor 3 and a command position inputted. Specifically, the learning unit 12 determines parameters representing the network structure of the NN by learning, and stores the parameters as learning results. The parameters representing the network structure correspond to a weight parameter, a bias parameter, and so on. The learning unit 12 calculates the parameters using a known technique such as back propagation. Generally, when the network configuration becomes complicated, it takes much calculation time. The learning unit 12 may perform calculation of the parameters in a cycle (hereinafter referred to as learning cycle) different from both the command value generation control cycle and the servo control cycle described above. The learning cycle is longer than both the command value generation control cycle and the servo control cycle.

The servo control device 1 stores the parameters representing the network structure of the NN, which are the results of learning by the learning unit 12, in a storage area inside the learning unit 12 or outside the learning unit 12. This allows the user to check what type of network structure is adopted in the servo control device 1.

The learning unit 12 may be configured to perform learning by combining the position, speed, or acceleration of the servomotor 3, motor current flowing through the servomotor 3, a model position calculated in the servo amplifier 11, and the like, in place of using the position of the servomotor 3.

A model position is an approximate position of the servomotor 3 determined by calculation, and is an estimated actual position of the servomotor 3. A model position can be estimated by passing a command position through a servo model simulating the structure of the servomotor 3. This servo model is simply defined as a first-order lag filter having a cutoff frequency according to position loop gain, and can generally be used as a filter having a low-pass characteristic.

By comparing a model position obtained by calculation and the actual position of the servomotor 3, it is possible to extract a model position error, which is a characteristic that cannot be modeled by the servo model. The model position error is an error between the model position and the actual position of the servomotor 3.

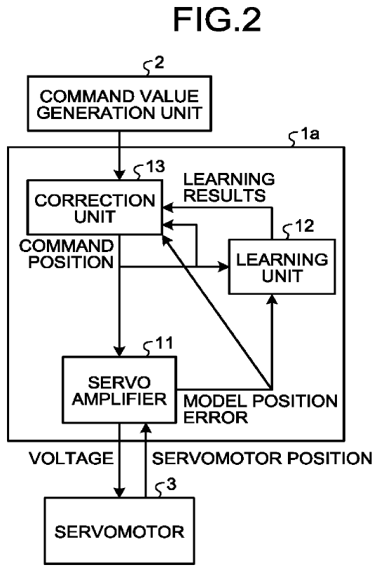

A case where the learning unit 12 performs learning using a model position error will be described. The configuration of the servo control device in this case is as illustrated in FIG. 2. FIG. 2 is a diagram illustrating another configuration example of the servo control device according to the first embodiment. Like the servo control device 1 illustrated in FIG. 1, a servo control device 1a illustrated in FIG. 2 includes the servo amplifier 11, the learning unit 12, and the correction unit 13. However, in the servo control device 1a, the servo amplifier 11 calculates model position error by the above-described method, and outputs the model position error to the learning unit 12. The learning unit 12 calculates the parameters representing the network structure of the NN, using a command position inputted from the correction unit 13 and a model position error inputted from the servo amplifier 11. Although the servo control device 1 and the servo control device la use different information to control the servomotor 3, the control operation itself is the same. Therefore, detailed description of the servo control device la will be omitted.

Learning results in the learning unit 12 are transferred to the correction unit 12 at intervals of a preset learning cycle. Note that the learning cycle may be set based on the processing time required for learning in the learning unit 12.

As with the learning unit 12, the correction unit 13 includes an NN, and predicts the position of the servomotor 3 at a fixed time ahead, using the weight parameter and so on, which are the learning results obtained by the learning unit 12. At this time, the correction unit 13 performs NN calculation (inference processing) based on a corrected command position to be outputted to the servo amplifier 11 and the actual position of the servomotor 3, to predict the position of the servomotor 3 at the fixed time ahead. After predicting the position of the servomotor 3 at the fixed time ahead, the correction unit 13 calculates the correction amount of the command position so that the position of the servomotor 3 coincides with the command position, using the position of the servomotor 3 at the fixed time ahead, and corrects the command position. The NN of the correction unit 13 corresponds to a first neural network, and the NN of the learning unit 12 corresponds to a second neural network.

Further, as described above, because the learning unit 12 performs learning in the learning cycle, and outputs learning results to the correction unit 13, the correction unit 13 updates the parameters representing the network structure of the NN every time the correction unit 13 receives learning results from the learning unit 12, that is, for each learning cycle. As a result, the parameters representing the network structure of the NN used by the correction unit 13 become equal to the parameters representing the network structure of the NN that has been used in learning by the learning unit 12.

For example, the correction unit 13 can determine the correction amount by calculating a transfer function with a corrected command position as the input and the position of the servomotor 3 as the output, and letting a position error of the servomotor 3 be the input to the inverse transfer function, so as to minimize the influence of friction disturbance. The position error of the servomotor 3 is an error between the actual position of the servomotor 3 and the corrected command position. When the command position has high frequency components, the high frequency components may be removed through a filter such as a low-pass filter. At this time, there is a trade-off relationship between the position error of the servomotor 3 and vibration reduction effect of reducing the vibration of the machine tool driven by the servomotor 3. Therefore, the correction unit 13 may change the setting of the transfer function according to the machine tool to be controlled.

As described above, the servo control device 1 illustrated in FIG. 1 according to the present embodiment includes the correction unit 13 that corrects a command position by using the NN, the servo amplifier 11 that controls the servomotor 3 based on the corrected command position, and the learning unit 12 that determines the parameters representing the structure of the NN constituting the correction unit 13, based on the corrected command position and the actual position of the servomotor 3. The learning unit 12 of the servo control device 1a illustrated in FIG. 2 determines the parameters representing the structure of the NN constituting the correction unit 13, based on a corrected command position and a model position error. Thus, while the correction unit 13 is executing the correction processing, it is possible to change the parameters representing the structure of the NN constituting the correction unit 13, thereby improving the performance of the correction processing.

In the servo control devices 1 and 1a illustrated in FIGS. 1 and 2, a corrected command position is inputted to the learning unit 12 for the learning processing. Thus, it is possible to learn behavior in a range not including the correction unit 13. That is, the learning unit 12 can learn the relationship between a corrected command position and the actual position of the servomotor 3, and can prevent the behavior of the correction unit 13 from being included in that range. As a result, not only in a state where the command position correction is suspended but also while the command position correction is being executed, the learning unit 12 can learn the structure of the NN simulating the input and output relationship of the servomotor 3. That is, processing related to the control of monitoring and modeling the relationship between corrected command position inputted to the servo amplifier 11 and the actual position of the servomotor 3, and determining the parameters representing the network structure of the NN is performed outside processing from input of a command position to the correction unit 13 to generation of a voltage to be applied to the servomotor 3 by the servo amplifier 11, so that the learning can be continued without changing the characteristics of the command position correction processing.

Moreover, by using the NN as the network structure, it is possible to learn the characteristics of a servo control system including mechanical characteristics by the NN, and to also learn similar operation patterns. Consequently, even for a machining program that has not been executed in the past, it is possible to obtain an appropriate correction amount with reference to a machining program having a high similarity among machining programs that have been executed in the past, and it is possible to perform control with high precision from initial product machining after the execution of the machining program. Therefore, it is possible to achieve such a special effect as being able to prevent a decrease in productivity due to preliminary operation.

In addition, it is unnecessary to adjust control parameters using the command position correction processing, which has been done by human hands so far.

### Second Embodiment

Next, a servo control device according to a second embodiment will be described. Hereinafter, a description will be given focusing on parts different from the parts in the first embodiment.

In the first embodiment, a description has been given of a servo control device that performs learning in a preset learning cycle, and updates parameters used for correcting command positions. In contrast, in the servo control device according to the present embodiment, the timing of learning is automatically determined in accordance with changes in mechanical characteristics accompanying aged deterioration, changes in control parameters, or the like.

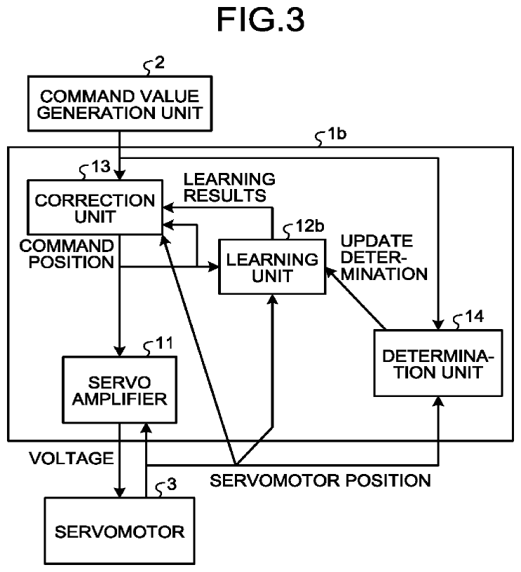

FIG. 3 is a diagram illustrating a configuration example of the servo control device according to the second embodiment. In FIG. 3, the same reference numerals are assigned to the same components as the components of the servo control device 1 illustrated in FIG. 1.

A servo control device 1b according to the second embodiment includes the servo amplifier 11, a learning unit 12b, the correction unit 13, and a determination unit 14. That is, the servo control device 1b has a configuration in which the learning unit 12 of the servo control device 1 is replaced with the learning unit 12b, and the determination unit 14 is added.

The learning unit 12b performs learning with the same timing and by the same method as the learning unit 12, and outputs parameters as learning results to the correction unit 13 when receiving an instruction from the determination unit 14.

A command position generated by the command value generation unit 2 and the position of the servomotor 3 are inputted to the determination unit 14. Based on the command position and the position of the servomotor 3 inputted, the determination unit 14 determines whether or not it is the timing to apply the results of learning by the learning unit 12b to the correction unit 13, that is, whether or not it is necessary to update the parameters representing the network structure of the NN of the correction unit 13. Specifically, the determination unit 14 determines whether or not the error between the position of the servomotor 3 and the command position has exceeded a preset threshold value at the servo control cycle intervals described in the first embodiment, or another preset cycle intervals. Then, when the error has exceeded the threshold value, the determination unit 14 instructs the learning unit 12b to output learning results to the correction unit 13.

Consequently, when the characteristics of the machine driven by the servomotor 3 have changed over time, the servo control device 1b can detect an increase in the error between the position of the servomotor 3 and a command position, and perform correction taking the latest characteristics into consideration by using the latest learning results.

The determination unit 14 may not only determine whether or not the results of learning by the learning unit 12b should be applied to the correction unit 13, but also determine whether or not the learning unit 12b should perform learning. In this case, when the error has exceeded the threshold value, the determination unit 14 instructs the learning unit 12b to execute learning. Upon receiving this instruction, the learning unit 12b executes learning and outputs the learning results to the correction unit 13. In this case, since a calculation load in the learning unit 12b is reduced, efficient operation can be achieved.

In this way, to a problem that sequential update of learning results in the learning unit 12b increases the calculation load of the learning unit 12b and processing load for the correction unit 13 to reflect the learning results, learning execution frequency is reduced, thereby allowing efficient correction using the latest learning results.

The determination unit 14 may not only monitor the error between the position of the servomotor 3 and a command position before correction, but also monitor parameters constituting the servomotor 3, specifically changes in parameters such as a position gain and a speed gain, and suspend the calculation processing of correction amount in the correction unit 13 until the learning of the learning unit 12b in a state after a parameter change is completed. This makes it possible to avoid mismatches between learning results and control characteristics.

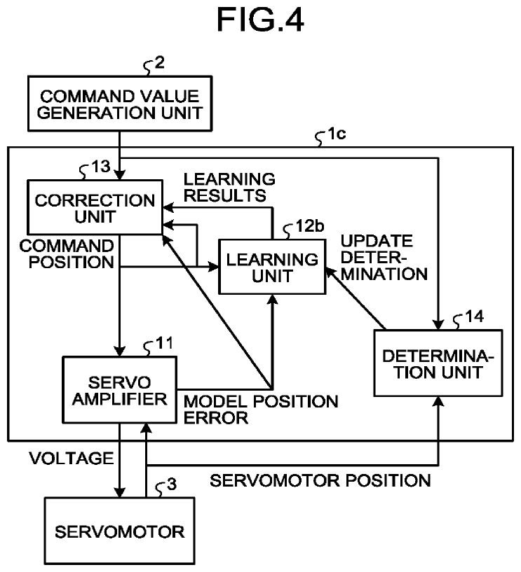

It is to be noted that although an example where the addition of the determination unit 14 and so on are performed to the servo control device 1 illustrated in FIG. 1 has been described, the addition of the determination unit 14 and so on may be performed to the servo control device 1a illustrated in FIG. 2. In this case, the configuration illustrated in FIG. 4 is obtained. A servo control device 1c illustrated in FIG. 4 has a configuration in which the learning unit 12 of the servo control device 1a is replaced with the above-described learning unit 12b, and further the above-described determination unit 14 is added.

As described above, the servo control devices 1b and 1c according to the present embodiment include the determination unit 14 that determines whether or not it is necessary to update the parameters representing the structure of the NN constituting the correction unit 13. Consequently, it can be achieved that learning results in the learning unit 12b are appropriately and efficiently used by the correction unit 13, and it is possible to prevent degradation of the accuracy of the position command correction.

### Third Embodiment

In the present embodiment, details of the correction unit 13 included in the servo control device described in the first and second embodiments will be described. Components other than the correction unit 13 are the same as those in the first and second embodiments, and thus will not be described.

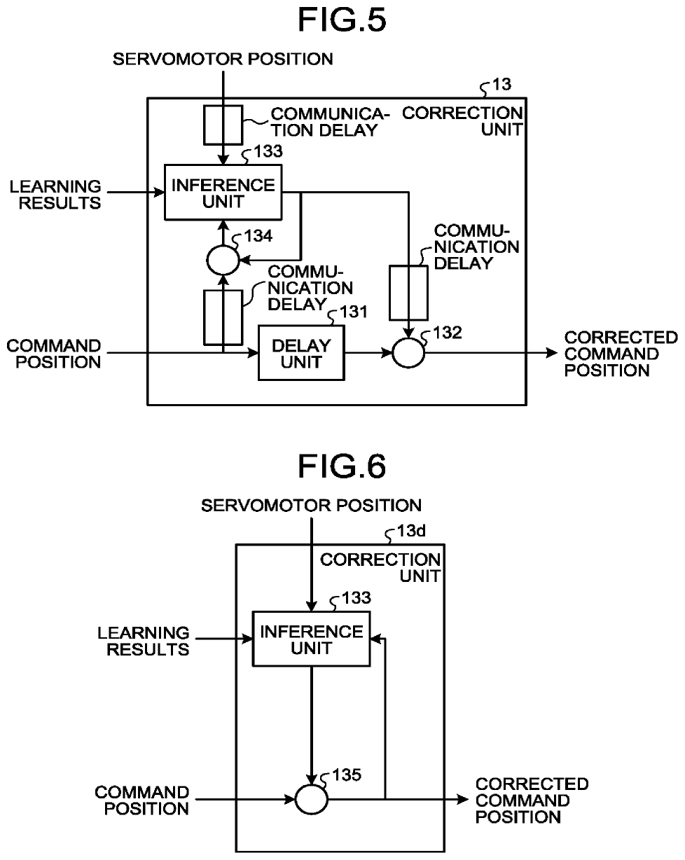

FIG. 5 is a diagram illustrating a configuration example of a correction unit according to the third embodiment. As illustrated in FIG. 5, the correction unit 13 includes a delay unit 131, adders 132 and 134, and an inference unit 133. Although details will be described later, the inference unit 133 calculates the correction amount. It is assumed that a signal delay, that is, a communication delay occurs in an input path to and an output path from the inference unit 133. It is considered that this communication delay occurs when the inference unit 133 is realized by a device different from a device performing servo control, or a different processing circuit. However, a communication delay time is made to be a fixed delay time. Thus, the delay time does not greatly fluctuate beyond the control cycle.

The delay unit 131 is a circuit capable of delaying the output of a signal by designating a delay time in advance. That is, when a command position generated by the command value generation unit 2 is inputted, the delay unit 131 delays the command position by a predetermined time and then outputs the delayed command position to the adder 132. By providing a delay to a command position by the delay unit 131, for example, the difference between the timing at which a corrected command position obtained by adding a correction amount to a certain command position reaches the inference unit 133 and the timing at which the corrected command position reaches the servo amplifier 11 can be adjusted. The delay unit 131 has a storage area equal to or larger than a size determined based on a command position update cycle and a delay time provided to a command position.

The delay time provided to an input command position by the delay unit 131 is a value based on a communication delay time that occurs in a path through which a command position inputted from the outside is inputted to the inference unit 133, and a communication delay time that occurs in a path from the inference unit 133 to the adder 132.

It is also possible that the delay unit 131 be set to output an input command position without delay. In this case, the correction unit 13 has a configuration illustrated in FIG. 6. FIG. 6 is a diagram illustrating a configuration example of a correction unit in the case where no communication delay occurs. A correction unit 13d illustrated in FIG. 6 includes the inference unit 133 and an adder 135. The inference unit 133 is the same as the inference unit 133 illustrated in FIG. 5. When a communication delay does not occur, or the communication delay causes no problem in an input path of a signal to the inference unit 133 and an output path of a signal from the inference unit 133, the correction unit 13d having the configuration illustrated in FIG. 6 may be used.

Returning to the explanation of FIG. 5, the adder 132 adds a correction amount inputted from the inference unit 133 to a command position inputted via the delay unit 131, to correct the command position. The adder 132 is a first adder that adds a correction amount calculated by the inference unit 133 to a command position, thereby generating a corrected command position to be outputted to the servo amplifier 11. The adder 134 adds a correction amount inputted from the inference unit 133 to an input command position to correct the command position. The adder 134 is a second adder that adds a correction amount calculated by the inference unit 133 to a command position, thereby generating a corrected command position to be inputted to the inference unit 133. The adders 132 and 134 may be configured to also have a function as a delay unit to be able to adjust the timing to add a command position and a correction amount.

The inference unit 133 is formed by an NN, and the network structure of the NN follows learning results received from the learning unit 12 or 12b.

The inference unit 133 predicts the position of the servomotor 3 in at least one command value generation cycle or more ahead, based on the actual position of the servomotor 3 and a command position inputted via the adder 134, and further calculates a correction amount using the prediction result. As described in the first embodiment, the calculation of a correction amount performed by the inference unit 133 is performed using a known technique, such as using a transfer function with a corrected command position as the input and the position of the servomotor 3 as the output. A read-ahead time that is a time in one command value generation cycle or more ahead is a time taking into consideration communication delays until input and output results to the inference unit 133 are obtained. The inference unit 133 outputs a calculated correction amount to the adders 132 and 134.

FIG. 7 is a flowchart illustrating an example of an operation procedure of the correction unit 13 according to the third embodiment. The correction unit 13 executes processing by the procedure illustrated in FIG. 7 to correct an input command position.

First, the correction unit 13 inputs a command position received from the outside to the adder 134 and the delay unit 131 (step S1). At this time, a communication delay occurs in the communication path to the adder 134, and the command position is inputted to the adder 134 later than the timing at which the command position is inputted to the delay unit 131.

Next, the inference unit 133 predicts the position of the servomotor 3 at a fixed time ahead using learning results received from the learning unit, and calculates a correction amount at the fixed time ahead (step S2).

Next, the inference unit 153 outputs the calculated correction amount to the adders 134 and 132 (step S3).

Next, the adder 134 adds the correction amount to a command position at the next time. This corresponds to input of a corrected command position to the inference unit 133. The adder 132 also adds the correction amount to the command position that has been delayed by the delay unit 131, thereby correcting the command position (step S4). It should be noted that the command position outputted from the adder 134 and the command position outputted from the adder 132, which are outputted at different timings, have the same value.

As described above, the correction unit of the servo control device according to the present embodiment includes the delay unit that causes a delay in the timing at which a command position is inputted, to adjust the timing at which a correction amount is added to the command position. This makes it possible to adjust the timing at which a correction amount is added to a command position to an appropriate timing even when delay occurs in the paths through which the command position is transmitted.

Next, the configuration of hardware that realizes the correction unit, the learning unit, and the determination unit of servo control device described in the embodiments will be described.

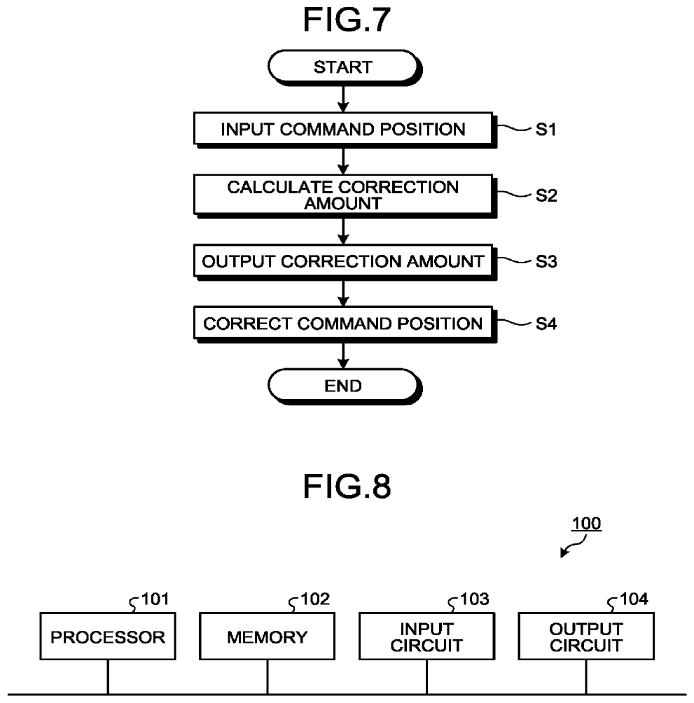

The correction unit 13, the learning unit 12 or 12b, and the determination unit 14 described in the first to third embodiments can be realized by a processing circuit 100 illustrated in FIG. 8.

The processing circuit 100 includes a processor 101, a memory 102, an input circuit 103, and an output circuit 104. The processor 101 is a Central Processing Unit (CPU, also called a central processor, a processing unit, an arithmetic unit, a microprocessor, a microcomputer, a processor, and a DSP), a system Large Scale Integration (LSI), or the like. The memory 102 is nonvolatile or volatile semiconductor memory such as Random Access Memory (RAM), Read Only Memory (ROM), flash memory, an Erasable Programmable Read Only Memory (EPROM), or an Electrically Erasable Programmable Read-Only Memory (EEPROM), or a magnetic disk, a flexible disk, an optical disk, a compact disk, a mini disk, a Digital Versatile Disc (DVD), or the like.

The correction unit 13, the learning unit 12 or 12b, and the determination unit 14 can be realized by the processor 101 reading their respective corresponding programs from the memory 102 and executing the programs. The input circuit 103 is used for receiving from the outside information to be processed by the processor 101, information to be stored in the memory 102, and the like. The output circuit 104 is used for outputting to the outside information generated by the processor 101 and information stored in the memory 102.

The correction unit 13 and the learning unit 12 or 12b may be realized by different processing circuits 100. In this case, the correction unit 13 has the configuration described in the third embodiment, and the processing circuit 100 realizes the inference unit 133 illustrated in FIG. 5. That is, the correction unit 13 according to the third embodiment is realized by a delay unit and adders in addition to the processing circuit 100.

The servo amplifier 11 is realized by a dedicated circuit including a conversion circuit that converts a voltage supplied from the outside to generate a voltage to be applied to the servomotor 3, a control circuit that controls the conversion circuit, and so on.

The configurations illustrated in the above embodiments illustrate an example of the subject matter of the present invention, and can be combined with another known art, and can be partly omitted or changed without departing from the scope of the present invention.

### REFERENCE SIGNS LIST

1, 1a, 1b, 1c servo control device; 2 command value generation unit; 3 servomotor; 11 servo amplifier; 12, 12b learning unit; 13, 13d correction unit; 14 determination unit; 131 delay unit; 132, 134, 135 adder; 133 inference unit.

1. A servo control device to control a servomotor based on a command position, the servo control device comprising:
a correction unit to correct the command position using a first neural network to perform processing based on parameters representing a network structure; and
a servo amplifier to control the servomotor based on a corrected command position outputted from the correction unit,
wherein the correction unit corrects the command position based on the corrected command position and an actual position of the servomotor.

2. The servo control device according to claim 1,
wherein the correction unit predicts an actual position of the servomotor based on the corrected command position and the actual position of the servomotor, and corrects the command position based on a prediction result.

3. The servo control device according to claim 1, further comprising
a learning unit to determine the parameters based on the corrected command position and the actual position of the servomotor.

4. The servo control device according to claim 3,
wherein the learning unit determines the parameters using a second neural network.

5. The servo control device according to claim 4,
wherein the learning unit determines the parameters based on the corrected command position and a model position error representing an error between a model position that is an estimated actual position of the servomotor calculated using the corrected command position, and the actual position of the servomotor.

6. The servo control device according to claim 3,
wherein the learning unit determines the parameters in a cycle different from a command value generation control cycle that is a cycle in which the command position is inputted and a servo control cycle that is a cycle in which the servo amplifier controls the servomotor.

7. The servo control device according to claim 3,
wherein when the learning unit determines the parameters, the learning unit applies the determined parameters to the correction unit.

8. The servo control device according to claim 3, further comprising
a determination unit to determine a timing at which the parameters determined by the learning unit are applied to the correction unit, based on the command position and the actual position of the servomotor,
wherein the learning unit applies the determined parameters to the correction unit according to a result of the determination by the determination unit.

9. The servo control device according to claim 1,
wherein the correction unit comprises:
an inference unit to predict an actual position of the servomotor based on the corrected command position and the actual position of the servomotor, and calculate a correction amount of the command position based on a prediction result;
a first adder to add the correction amount calculated by the inference unit to the command position, thereby generating a corrected command position to be outputted to the servo amplifier;
a delay unit to delay the command position and then input the command position to the first adder; and
a second adder to add the correction amount calculated by the inference unit to the command position, thereby generating a corrected command position to be inputted to the inference unit.
